(19) United States
(12) Patent Application Publication
(10) Pub. No.: US 2006/0017309 A1
(43) Pub. Date: Jan. 26, 2006

(54) Cross member having a hybrid structure

(75) Inventor: Walter Wolf, Oppenweiler-Zell (DE)

Correspondence Address: FOLEY AND LARDNER LLP;SUITE 500, 3000 K STREET NW, WASHINGTON, DC, 20007, US

(73) Assignee: BEHR GmbH & Co. KG, Stuttgart (DE)

(21) Appl. No.: 10/533,892

(22) PCT Filed: Oct. 22, 2003
(86) PCT No.: PCT/EP03/11693

§ 371 Date: May 5, 2005

(30) Foreign Application Priority Data
Nov. 5, 2002 (DE) 102 51 761.4

(51) Int. Cl. B60J 7/00

(52) U.S. Cl. 296/193.02

(57) ABSTRACT

The invention relates to a cross member for a vehicle, said cross member comprising a reinforced base body (2, 2b, 2c) containing at least one air duct (14) and being embodied in an at least partially widened manner and as part of a housing (11) of a heating and/or air conditioning installation (12). Said air duct (14) of the base body (2) is connected to an air outlet (15) of the heating and/or air conditioning installation (12).

The invention relates to a crossmember having a hybrid structure for a vehicle, in particular for arranging between A-pillars of a vehicle, comprising a basic body which is provided with a reinforcement and in which at least one air duct is arranged and which is furthermore at least partially widened and is designed as part of a housing of a heating and/or air-conditioning system.

A crossmember of this type having a hybrid structure is disclosed, for example, in DE 100 14 606 A1. In this case, in order to attach additional functions, the crossmember is at least partially widened, at least on one side, in particular in the central region, and is designed as part of a housing of a heating and/or air-conditioning system. In addition to a large construction space, this also gives rise to a complex geometry for the crossmember, in particular a crossmember with an integrated air duct. The widened area results in a curved profile of the crossmember, in which a cover and a separate air duct are generally subsequently required. Furthermore, the heating and/or air-conditioning system additionally has a branched air distribution device and is therefore heavy, since the flow ducts or air distribution ducts are usually formed from injection molded, hard, dimensionally stable shells or blow-molded components. Due to complex geometries, the production of rigid flow ducts of this type is particularly complicated and cost-intensive.

The invention is therefore based on the object of specifying a crossmember having a hybrid structure for a vehicle, which has a particularly small construction volume.

According to the invention, the object is achieved by a crossmember having a hybrid structure for a vehicle, comprising a basic body which is provided with a reinforcement and in which at least one air duct is arranged and which is furthermore at least partially widened and is designed as part of a housing of a heating and/or air-conditioning system, with the air duct of the basic body being connected to an air outlet of the heating and/or air-conditioning system.

The invention is based on the consideration that a crossmember for the integration of functional elements, in particular in the form of a supporting element for a heating and/or air-conditioning system, is to be simplified in such a manner that, in addition to the supporting-element function, it also enables air to be fed directly to air exits with a complex, branched duct system being avoided. In this case, in addition to the simplification of the duct routing, the weight is also to be significantly reduced and a duct routing which is favorable in terms of flow is to be made possible such that swirling of the fluid flowing through the flow duct is reliably avoided. For this purpose, the crossmember serving as a supporting element for a heating and/or air-conditioning system is firstly to be provided with an air duct which at suitable locations has openings via which the fluid, in particular air, can emerge. Secondly, the air duct which is integrated in the crossmember is connected to an air outlet of the heating and/or air-conditioning system. This significantly reduces the number of outlets from a heating and/or air-conditioning system. An air duct which is integrated in the crossmember and has a plurality of variable exit openings fitted and its connection to the air outlet of the heating and/or air-conditioning system make possible a particularly simple and standardizable air distribution device which requires a particularly small amount of construction space. Owing to the simple construction and the particularly variable adjustment of the exit openings, a resultant air distribution device can be adjusted and designed individually in accordance with requirements, thus permitting particularly high thermal comfort.

To arrange the crossmember and the course thereof in as individual a manner as possible, the basic body is expediently arranged in a manner such that it partially encircles the heating and/or air-conditioning system. For example, for this purpose the basic body is at least partially widened in one region in such a manner that it encircles the heating and/or air-conditioning system at the top, bottom, front and/or rear. For such great design freedom in the member profile, the basic body comprises at least two subsections which are connected via a third subsection forming a widened area. In other words: the basic body is expediently divided into a plurality of subsections, with at least two running rectilinearly and uniformly and another running at least partially in a curved manner.

For an arrangement of the heating and/or air-conditioning system which is as space-saving and construction-space-saving as possible, said system is expediently arranged in the region of the third subsection on the outer side thereof, with the two subsections being oriented at the sides of the heating and/or air-conditioning system in the form of side arms. In this case, the side arms run substantially rectilinearly and uniformly whereas the third subsection runs in a curved manner in order to accommodate the heating and/or air-conditioning system.

For feeding in air as simply as possible and for a particularly high pickup of the flow and with turbulence being avoided, the air outlet of the heating and/or air-conditioning system opens into the air duct of one of the subsections forming a side arm. As an alternative or in addition, the air outlet opens into the air duct arranged in the widened region of the basic body, i.e. in the third subsection, and/or runs through or crosses said duct. In a further alternative embodiment, the basic body is at least partially formed from two ducts arranged parallel to each other. In this case, the air duct is expediently at least partially guided between the ducts arranged parallel to each other.

Depending on the type and design, the air duct is preferably formed in the basic body. As an alternative or in addition, the air duct can be formed by a separate molded part. For a connection of the air duct to the air outlet in a manner irrespective of constructional form, an adapter is expediently provided. For as variable as possible a design and configuration of the adapter element, the latter is advantageously formed from plastic.

The advantages obtained with the invention reside in particular in the fact that a crossmember which serves as a supporting element for a heating and/or air-conditioning system and has an integrated air duct connected to an air outlet of the heating and/or air-conditioning system permits great freedom in configuration and design in the member profile. In addition, such a multifunctional crossmember has a particularly low construction volume and, owing to the air duct bringing about an additional stiffening function, makes it possible for further holders to be integrated on the crossmember. Furthermore, the crossmember has a particularly lightweight structure with, at the same time, good crash absorption and as good a vibration damping as possible.

Exemplary embodiments of the invention are explained in more detail with reference to a drawing, in which:

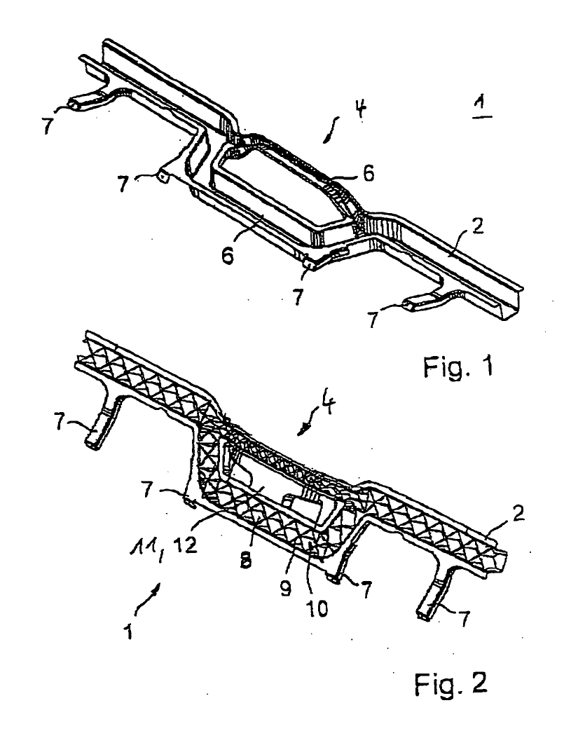

FIG. 1 diagrammatically depicts a basic body for a crossmember,

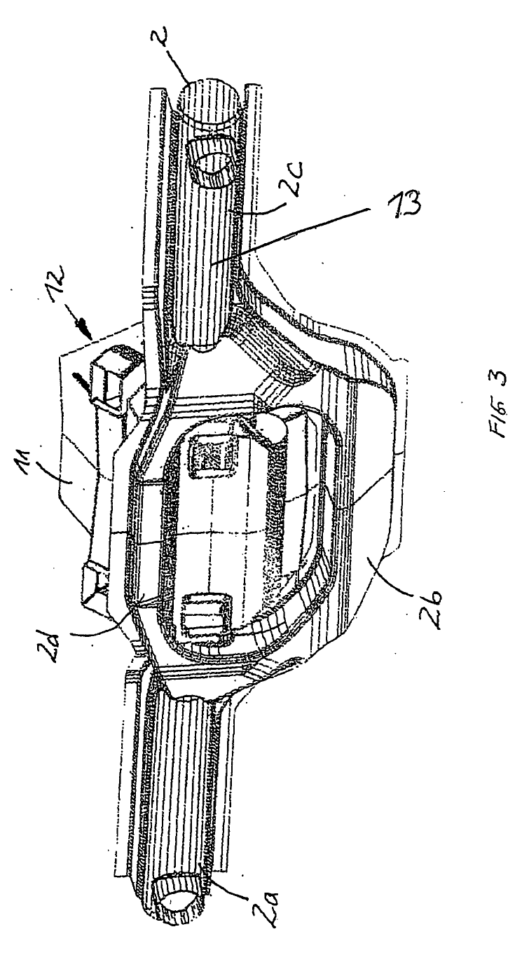

FIG. 2 diagrammatically depicts a hybrid member as shown in FIG. 1,

FIG. 3 diagrammatically depicts, in a perspective illustration, a crossmember with an integrated heating and/or air-conditioning system,

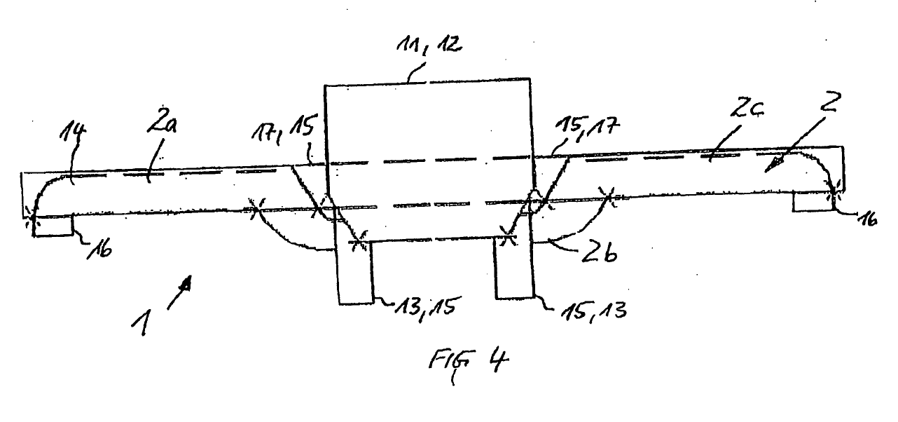

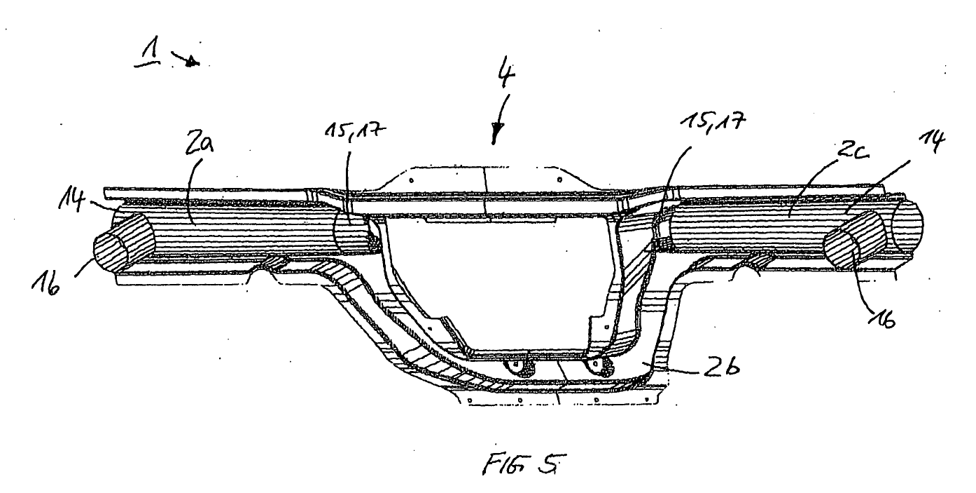

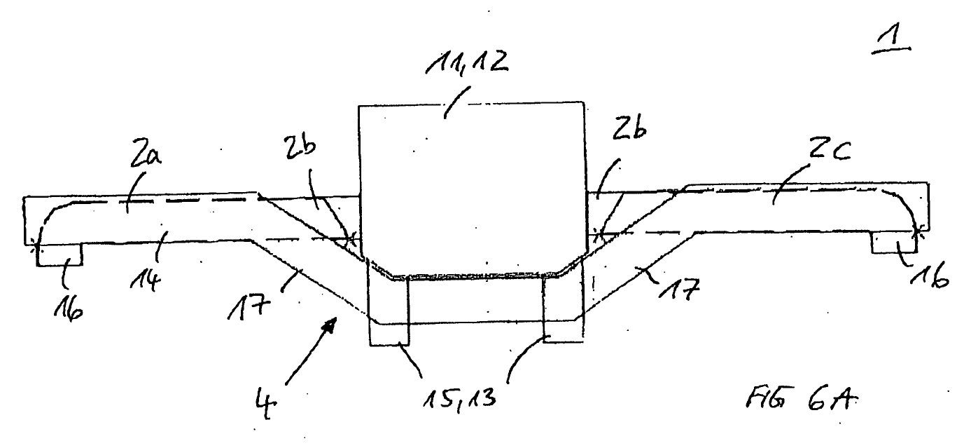

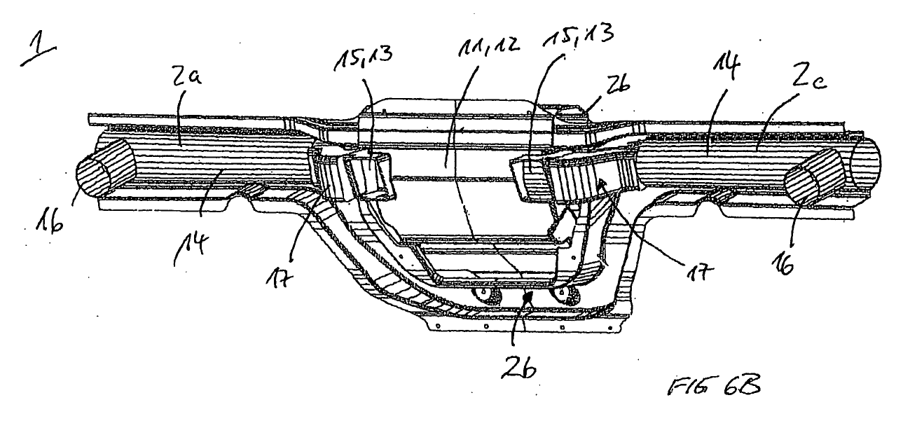

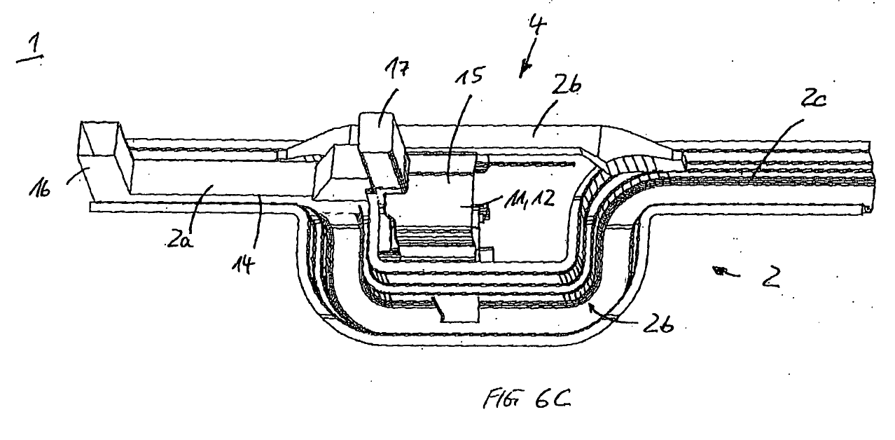

FIG. 4 diagrammatically depicts, in a perspective illustration, a crossmember with a heating and/or air-conditioning system connected to an air duct of the crossmember via an air outlet,

FIG. 5 diagrammatically depicts, in a perspective illustration, the crossmember as shown in FIG. 3,

FIG. 6A to 6C diagrammatically depict an alternative embodiment for a crossmember with an integrated air duct and heating and/or air-conditioning system connected thereto, and

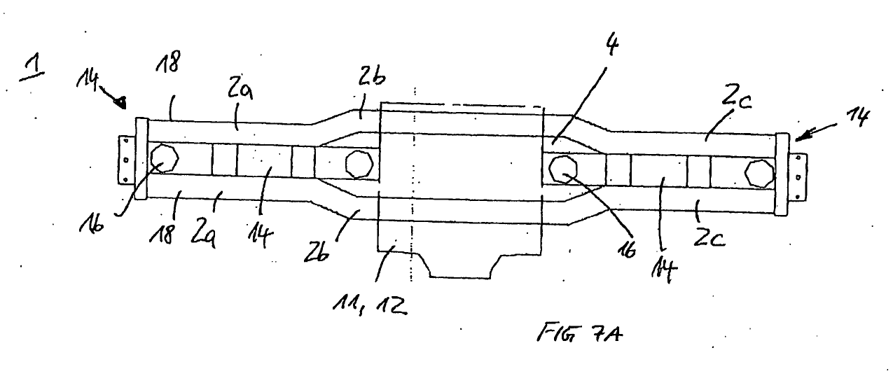

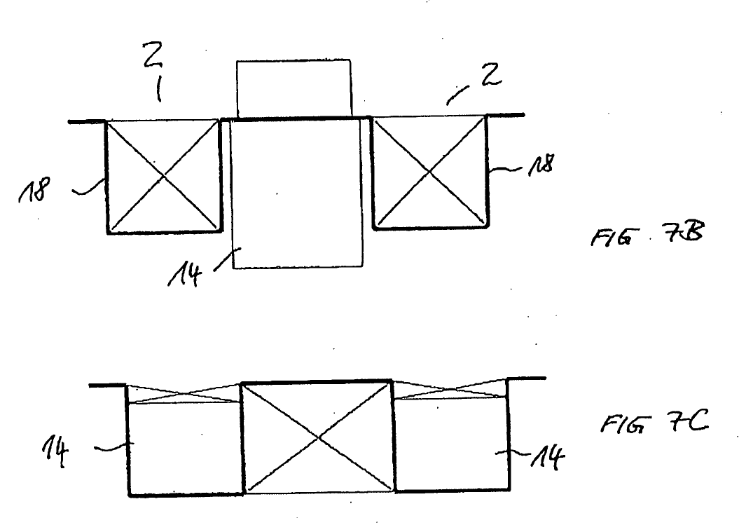

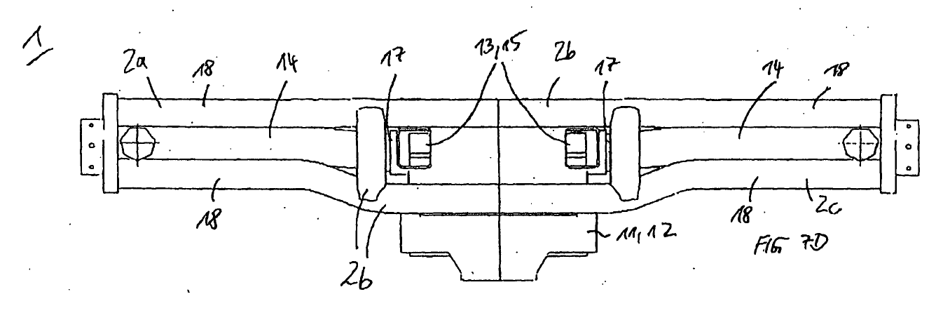

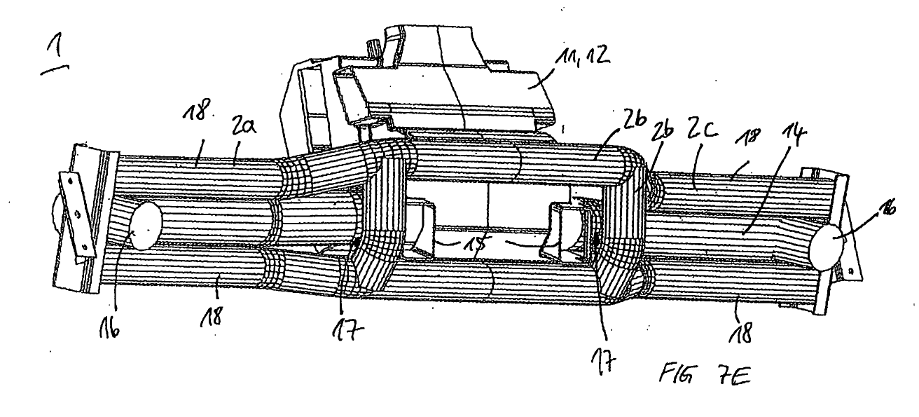

FIG. 7A to 7E diagrammatically depict an alternative embodiment for a crossmember with ducts arranged parallel to one another and an air duct arranged in between and a heating and/or air conditioning system connected to said duct.

Parts which correspond to one another are provided with the same reference numbers in all of the figures.

FIGS. 1 and 2 show a crossmember 1 having a hybrid structure for a vehicle, which, for the connection of functional elements, such as, for example, the instrument panel or airbags, is arranged between the A-pillars of the vehicle. The crossmember 1 has a basic body 2 which is formed from a bent sheet-metal part. The basic body 2 has an essentially U-shaped, slightly open profile, with the two open limb ends being bent outward. The basic body 2 is widened in the central region 4, i.e. when it is fitted into a vehicle in the region of the central console, the basic body 2 is divided into two subsections 6, with each subsection 6 likewise having a corresponding, essentially U-shaped, slightly open profile. As an alternative, the basic body 2 may also be designed as a hollow profile with any desired cross section. In order to connect functional elements, such as, for example, airbags, knee impact protection and/or in order to fasten an instrument panel, a plurality of connections 7 are provided on the basic body 2. Depending on the type and design, the connections 7 are designed as bent sheet-metal parts which are arranged in a form-fitting manner on the basic body 2 and are permanently connected by means of a welding connection. However, the connection may also take place by a different joining method. The connection 7 may also be formed in a hybrid structure, i.e. as an injection-molded plastic part.

To increase the stability of the basic body 2, a reinforcement, also called profiled core, of plastic is provided, in particular fitted, as illustrated in FIG. 2, essentially in the interior of the in particular U-shaped profile and has a honeycomb structure 10 formed from ribs 9. The honeycomb structure 10 is designed here in such a manner that the ribs 9 are in each case arranged at an angle of approx. 45° to the side walls of the U-shaped profile of the basic body 2 and two ribs 9 meet in the edge region. To increase the stability, the plastic may have glass fibers added. Depending on the type and design, such a stiffening rib structure may also be provided in the connections 7 and may therefore bring about an increase in rigidity.

FIG. 3 shows an example of a connection of a housing 11 of a heating and/or air-conditioning system 12 to the basic body 2. The housing 11 is generally formed from plastic and injection-molded on or fastened to the basic body 2. As illustrated in FIG. 3, the basic body 2 at least partially encircles the heating and/or air-conditioning system 12. Depending on the arrangement of the heating and/or air-conditioning system 12 in the widened region 4, in particular in the central region of the crossmember 1, the basic body 2 may run at the front, rear, above and/or below the heating and/or air-conditioning system 12. For this purpose, the basic body 2 is divided into a plurality of subsections 2a to 2d, of which the subsections 2a, 2c form side arms of the crossmember 1 which are connected to one another via the subsection 2b, which forms the widened area and is therefore partially curved. Depending on the design of the basic body 2, the latter may be of single-part or multipart design.

Flow ducts 13 branch off from the housing 11 of the heating and/or air-conditioning system 12.

For a particularly simple and space-saving construction of the basic body 2 serving as a supporting element for the heating and/or air-conditioning system 12, an air duct 14 is integrated in it, as illustrated in FIG. 4. In this case, the air duct 14 additionally serves to stiffen the basic body 2 and is preferably formed from plastic. Depending on the type and design of the crossmember 1, the air duct 14 may be injected as a plastic element or may be fitted in the basic body 2 as a separate molded part.

In addition or as an alternative to the flow ducts 13 (FIG. 3), the heating and/or air-conditioning system 12 has at least one air outlet 15. In this case, the air outlet 15 is connected to the air duct 14 integrated in the subsection 2a in order to laterally ventilate the vehicle interior via exits 16 fitted in the basic body 2. In order to ventilate the front region, firstly a further air outlet 15 is provided which opens into the air duct 14 integrated in the subsection 2b and runs through said duct. Secondly, a further flow duct 13 of the heating and/or air-conditioning system 12 is provided, which flow duct directly ventilates the front region and crosses above or below the basic body 2, in particular the subsection 2b thereof. Depending on the type and construction of the air outlet 15 or of the air duct 14, an adapter element 17 may be provided to connect these components. In one preferred embodiment, the adapter 17 has (in a manner not illustrated specifically) a blocking element, for example a flap, for controlling the air flow. The adapter element 17 is preferably made from plastic and can therefore be shaped in accordance with the cross section of the air outlet 15 or of the air duct 14 to be connected. The adapter element 17 is preferably integrally formed on the crossmember 1, in particular on the basic body 2, and/or the air-conditioning system 12 (called HVAC for short).

FIG. 5 illustrates an embodiment of the crossmember 1 in perspective. In this case, by way of example for the driver's side or left side of the crossmember 1, i.e. for the subsection 2a, an air feed into the air duct 14 integrated therein is illustrated. For this purpose, the air duct 14 is guided through the side wall of the basic body 2 at the end of the subsection 2a designed as a side arm. The heating and/or air-conditioning system 12 is then, as shown in FIG. 4, connected from the rear to the basic body 2 in the widened region 4, with an associated, lateral air outlet 15 then opening into the air duct 14 of the subsection 2a.

FIGS. 6A to 6C show an alternative embodiment for the crossmember 1 with a heating and/or air-conditioning system 12 connected to the basic body 2 from the rear, said system being arranged in the central region 4 between two subsections 2b, arranged parallel to each other, or arms of the basic body 2, and running through them. The connection of the air outlet 15 of the heating and/or air-conditioning system 12 to the air duct 14 integrated in the basic body 2 is implemented by means of the adapter element 17. In this case, the adapter element 17 can be attached from the outside in a particularly simple manner. FIG. 6C shows a basic body 2 of this type in a perspective illustration.

FIGS. 7A to 7E show a further alternative embodiment for the crossmember 1. In this case, the basic body 2 and the subsections 2a to 2c thereof are formed from two ducts 18 arranged parallel to each other. The ducts 18 are also referred to as upper air flow and lower air flow. Between the ducts 18, the air duct 14 is arranged in the region of the side arms, i.e. in the region of the subsections 2a, 2c, of the basic body 2. As illustrated in FIGS. 7D and 7E, the air duct 14 is connected in the subsection 2a and 2c via the adapter element 17 to the air outlet 15 of the heating and/or air-conditioning system 12.

### LIST OF REFERENCE NUMBERS

1 Crossmember having a hybrid structure
2 Basic body
2a to 2d Subsections of the basic body
4 Widened region of the basic body
6 Subsections
7 Connections
8 Reinforcement
9 Ribs
10 Honeycomb structure
11 Housing of the heating and/or air-conditioning system
12 Heating and/or air-conditioning system
13 Flow duct of the heating and/or air-conditioning system
14 Air duct of the basic body
15 Air outlet of the heating and/or air-conditioning system
16 Exits
17 Adapter element
18 Ducts

1. A crossmember (1) having a hybrid structure for a vehicle, comprising a basic body (2) which is provided with a reinforcement (8) and in which at least one air duct (14) is arranged and which is at least partially widened and is designed as part of a housing (11) of a heating and/or air-conditioning system (12), characterized in that the air duct (14) of the basic body (2) is connected to an air outlet (15) of the heating and/or air-conditioning system (12).

2. The crossmember as claimed in claim 1, characterized in that the basic body (2) is arranged in a manner such that it at least partially encircles the heating and/or air-conditioning system (12).

3. The crossmember as claimed in claim 1, characterized in that the basic body (2) comprises at least two subsections (2a, 2c) which are connected via a third subsection (2b) forming a widened area.

4. The crossmember as claimed in claim 3, characterized in that the heating and/or air-conditioning system (12) is arranged in the region of the third subsection (2b) on the outside thereof, the two subsections (2a, 2c) being oriented at the sides of the heating and/or air-conditioning system (12) in the form of side arms.

5. The crossmember as claimed in claim 4, characterized in that the air outlet (15) opens into the air duct (14) of one of the subsections (2a, 2c) forming a side arm.

6. The crossmember as claimed in claim 1, characterized in that the air outlet (15) opens into the air duct (14), which is arranged in the widened region (4) of the basic body (2), and/or runs through said duct.

7. The crossmember as claimed in claim 1, characterized in that the basic body (2) is at least partially formed from two ducts (18) arranged parallel to each other.

8. The crossmember as claimed in claim 7, characterized in that the air duct (14) is at least partially guided between the ducts (18) arranged parallel to each other.

9. The crossmember as claimed in claim 1, characterized in that the air duct (14) is formed in the basic body (2).

10. The crossmember as claimed in claim 1, characterized in that the air duct (14) is formed by a separate molded part.

11. The crossmember as claimed in claim 1, characterized in that an adapter element (17) is provided for connecting the air duct (14) to the air outlet (15).

12. The crossmember as claimed in claim 11, characterized in that the adapter element (17) is formed from plastic.

13. The crossmember as claimed in claim 11, characterized in that the adapter element (17) is integrated onto the air-conditioning system (12) and/or onto the air duct (14).
